(19) United States
(12) Patent Application Publication
(10) Pub. No.: US 2019/0341187 A1
(43) Pub. Date: Nov. 7, 2019

(54) INDUCTIVE WIRING SYSTEM FOR WIRELESS POWER SUPPLY

(71) Applicant: Santos Francisco LASERNA LARBURU, Castro Urdiales, Cantabria (ES)

(72) Inventor: Santos Francisco LASERNA LARBURU, Castro Urdiales, Cantabria (ES)

(21) Appl. No.: 16/312,663

(22) PCT Filed: Jun. 21, 2017
(86) PCT No.: PCT/ES2017/000078

§ 371 Date: Jul. 17, 2019

(30) Foreign Application Priority Data
Jun. 22, 2016 (ES) U201600454

(51) Int. Cl. H01F 38/14; H02J 50/10

(52) U.S. Cl. CPC H01F 38/14; H05B 37/0272; H02J 50/10

(57) ABSTRACT

An inductive wiring system for the power supply of wireless devices running a two-way wiring with the “outgoing wire” placed together with the “return wire”. Thus, for supply beacons placed on pavements or walls, a groove is formed in the pavement or wall, except at those points where the beacons will be placed. At these points, a loop of wire will be coiled one or several times that will generate a variable magnetic field in its vicinity, transferring energy wirelessly to other devices through electromagnetic induction. To ensure that the inductive value of this wire loop can be predetermined, and is not random, a solid support part will be used on which the wire will be coupled so that the wire loops adopt a homogeneous shape and, therefore, said wire loops will have almost the same value of inductive coefficient.

The objective of this invention is a wiring system that allows to supply advantageously beacons or wireless lamps placed on flat solid surfaces, either horizontal such as roofs, motorways, or pavements, or vertical such as partitions, walls, or dykes.

### Prior Definitions

For a better understanding, the relevant terms often used in this document are defined below:

Wireless lamp: Lamp according to the utility model ES-1123205_U or similar, which has the quality of being able to be supplied remotely by an inductive source, and, therefore, does not need a socket or electrical connections on its surface.
Inductive wiring: Current conduction system formed by one or more conductors or electrical wires through which a high-frequency alternating current will circulate.

### FIELD OF APPLICATION OF THE INVENTION

The field of application of the present invention is primarily within the technical sector of the electric lighting industry.

### STATE OF THE ART

During recent years, “inductive power sources”, also known as “wireless feeders”, have started to become relevant. An inductive power source is created by an electrical inductor winding through which a variable current flows. As a result, a variable magnetic field is generated around the mentioned inductive power source. By bringing another electrical winding close to the inductive power source, as a result of the phenomenon of electromagnetic induction, a current (called induced current) is generated, which is variable and analogous to the current passing through the inductor winding of the power source.

This current induced in the winding allows the supply of electrical appliances in the same way as the current generated in a connection to two poles of different potential. However, at the moment, there are very few electrical devices that can be supplied from an inductive electrical source or wireless supplier.

In the field of the art relating to the power supply to wireless lamps, the inductive current sources can become the power supply wires themselves, without the need to use specific coils as inductors. The advantage of a wireless power supply has already originated the appearance of various patents and has resulted in power supply systems through underground wires that feed the surface beacons.

The author of this invention has registered a related utility model with reference number U201500443 regarding the power supply through inductive wiring. There are also patents such as the US 2002008973 which choose to bury the wires, being these wires the inducers of the current in the wireless beacons of the surface.

However, the present invention proposes an ingenious system of wiring, either on the surface or underground, which differs from the wiring described in previous inventions, which is totally new and increases the effectiveness of the wireless power supply to the beacons or wireless lamps.

### DESCRIPTION OF THE INVENTION

The present invention presents an inductive wiring system for the power supply to wireless devices, that only requires running a single wire conduit, only in the outgoing direction, as in a conventional installation. It also considers running a two-way wiring, but in this case, the “outgoing wire” will be placed closely together with the “return wire”.

Thus, in the case of wishing to supply beacons placed on pavements or walls, it will only be necessary to cut a groove in the pavement or wall for its installation, except at those points where the beacons will be placed. At these points, a loop of wire will be coiled one or several times that will generate a variable magnetic field in its vicinity, because of which energy can be transferred wirelessly to other devices through electromagnetic induction. To ensure that the inductive value of this wire loop can be predetermined, and is not random, a solid support part will be used on which the wire will be coupled so that the wire loops adopt a homogeneous shape and, therefore, said wire loops will have almost the same value of inductive coefficient (L). This support part will also serve as a reference for the separation distance between the loops and the devices to be supplied.

Along the sections without beacons or wireless lamps, the outgoing and return current will circulate through the wires inside the conduit, separated by a few millimetres between them. This disposition makes it possible that the losses due to inductive impedance are smaller in the linear sections of wire so that the voltage losses due to inductive impedance of the total wiring are decreased. As a result, the efficiency of the wiring is greater than in a two-way installation in which the outgoing wire is installed separately from the return wire.

In the case of pavement beacons for which pavement grooving and buried wire are chosen, a circular or rectangular recess will be made at the beacon points, usually at the same or greater depth as the linear groove along the sections without beacons, and a wire loop will be placed in said recess.

For rooftop installations, the wire will lie on the roof, and the wire loop will be previously located at the specific areas where the wireless lamps will be installed.

The wire loop will be formed when placed on the “support part”, a key element in this invention, thus forming a coil that is normally quasi-circular or optionally polygonal in shape. The shape of the coil is consequently determined by the shape of this support part.

The wire support part is a piece of a rigid material (wood, plastic, metal.) on which the wire is coupled or fitted.

The purpose of this piece is multiple:
It provides a homogeneous shape to all the coils formed by bending the wire and that will be repeated this way throughout the installation
It allows to know the inductive impedance of each wire loop made, and therefore allows the calculation of the total installation impedance
It facilitates the positioning and attaching of the wire loop on the perforated pavement, or the supporting surface in each case, such as on a ceiling, wall, floor, or any other place
It serves as a positioning reference (distance) with respect to the supporting plane of the wireless lamp

As a result, the inductive wiring system of the invention presents the following advantages:
It allows supplying beacons and wireless lamps in a way that the magnetic field is homogeneous for all of them. The field homogeneity is achieved thanks to the geometrically equal shape of all the wire coils formed by winding the wire on the support part. The field homogeneity is also achieved thanks to the fact that these coils formed with the wire will be at the same distance from the wireless lamps, since the support part will serve as a supporting reference.
It allows the pre-calculation of the total installation inductive impedance, since knowing the number of beacons also indicates the number of coils available in the installation. The total impedance will be directly related to the sum of the impedances of each homogeneous winding formed this way.
It allows the reduction of the electromagnetic radiation areas, thus decreasing the energy consumed at rest and stabilising the final consumption of the installation.

The material or the shape of the support part, or the material or the shape of the wire are not limiting of the present invention.

For experts in the field, other tasks, variants, advantages, and features of the invention will be derived in part from the description and in part from the practical use of the invention. The following examples and drawings are provided as illustrations, and are not intended to restrict the present invention.

### A BRIEF DESCRIPTION OF THE FIGURES

FIG. 1 shows a parallel disposition of inductive wiring according to state of the art, which presents an inducing area along its entire length, which generates a relatively large inductive impedance which increases on increasing the distance travelled by the wiring.

FIG. 1B shows one of the proposed inventive solutions, lacking the support part, in which the outgoing and return wires remain together except in the sections where a wireless beacon will be placed. In such sections, the wire presents a curve, winding, or wire loop (3) that induces a magnetic field.

FIG. 2 is an enlarged detail of FIG. 1B

FIG. 3 is a variant of FIG. 2 in which the wire is coiled twice around the support forming a wire loop (3) of greater inductive impedance.

FIG. 4 is a variant of FIG. 2 in which the wire is coiled three times around the support forming a wire loop (3) of greater inductive impedance.

FIG. 5 graphically presents the support parts (4) on which the outgoing and return wire will be supported to form a homogeneous wire loop (3). This figure shows one of the proposed inventive solutions in its entirety.

FIG. 6 shows a three-dimensional example of the circular support part (4)

FIG. 7 shows a three-dimensional example of the support part (4) in the shape of a cross

FIG. 8 shows a three-dimensional example of the support part (4) in the shape of a star

FIG. 9 shows a three-dimensional example of the support part (4) in the form of a cross, which shows how the wire can be fitted to form the wire loop. In this case, an example is shown forming the loop with the outgoing wire itself (1).

FIG. 9B is a variant of FIG. 9 in which it can be seen that the support part (4) also serves to provide a relative distance (D) with respect to the wireless lamp or beacon to be supplied from the wire loop

FIG. 10 is a variant of FIG. 1B, in which the outgoing and return wires stay together within the same conduit (5). In the sections where a beacon or wireless lamp will be placed, a wire loop (3) will be connected with an electrical arrangement “in series”.

FIG. 11 is a variant of FIG. 1B, in which the outgoing and return wires stay together within the same conduit (5). In the stages where a beacon or wireless lamp will be placed, a wire loop (3) will be connected with an electrical arrangement “in parallel”.

FIG. 12 is a variant of FIG. 10, in which already appears another of the complete proposed inventive solutions, which comprises an outgoing wire (1) and a return wire (2) both within a single conduit (5). To this conduit (5) will be connected the wire loops (3) formed around the support part (4), with an electrical configuration “in series”.

FIG. 13 is a variant of FIG. 11, in which already appears another of the complete proposed inventive solutions, which comprises an outgoing wire (1) and a return wire (2) both within a single conduit (5). To this conduit (5) will be connected the wire loops (3) formed around the support part (4), with an electrical configuration “in parallel”.

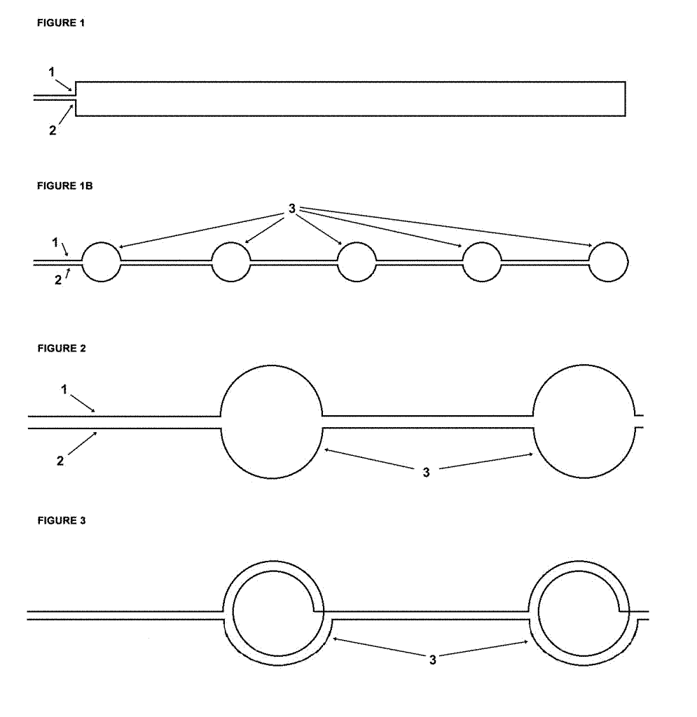

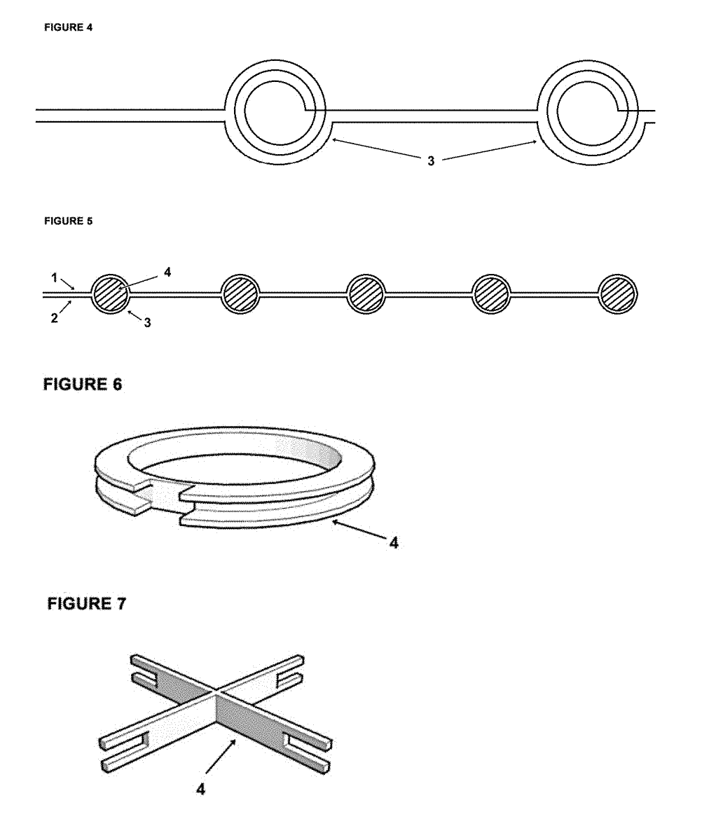

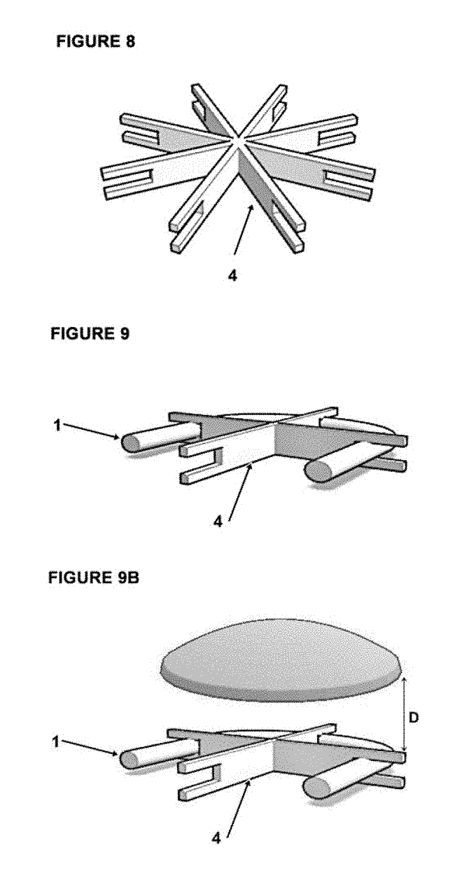

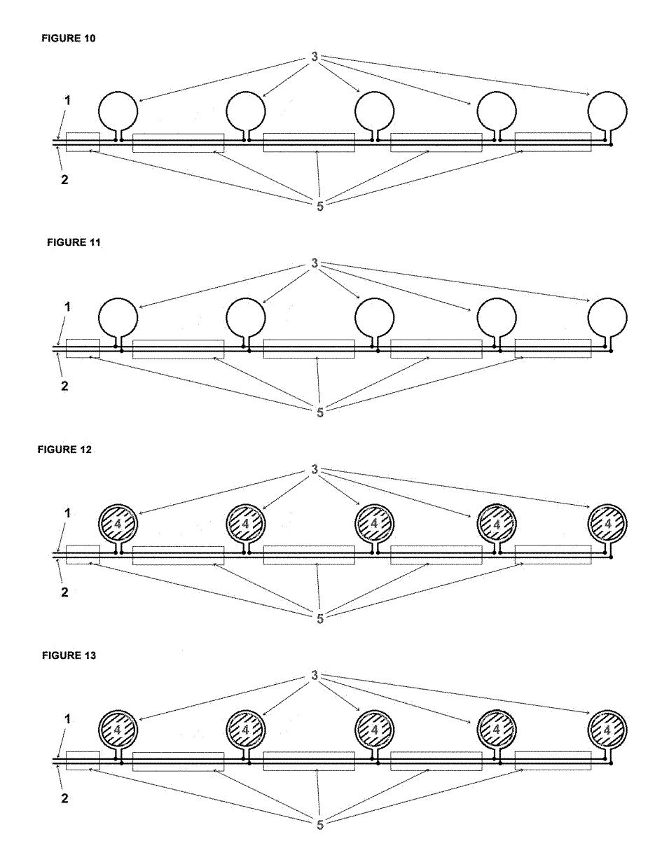

1.-10. (canceled)

11. Inductive wiring system for wireless power supply used to power electrical devices, wherein the system comprises a two-way wiring with an outgoing wire and a return wire, placed closely together and forming at least a wire loop that induces a magnetic field, being the wire loop homogeneous in shape and inductive value and coiled around a support piece that serves as a base for the electrical device.

12. The system of claim 11, wherein the outgoing wire and/or the return wire are coiled a number of times around the support piece forming a wire loop of greater inductive impedance.

13. The system of claim 11, wherein the support piece adopts a shape selected between a star, a cross, a circular shape and a polygonal shape.

14. The system of claim 13, wherein the support piece comprises at least and end designed in U-shape so that the outgoing wire and the return wire fit and/or adjust onto it.
